(19) United States
(12) Patent Application Publication
(10) Pub. No.: US 2021/0269656 A1
(43) Pub. Date: Sep. 2, 2021

(54) ANTIFOULING POLYMER COMPOSITE

(71) Applicant: NITTO DENKO CORPORATION, Osaka (KR)

(72) Inventors: Qianxi Lai, Carlsbad, CA (US); Tomonari Naito, Osaka (JP); Yiling Zhang, Oceanside, CA (US); Jiadong Zhou, San Diego, CA (US); Tao Gu, Carlsbad, CA (US)

(21) Appl. No.: 17/254,199

(22) PCT Filed: Jun. 28, 2019
(86) PCT No.: PCT/US2019/039734

§ 371 Date: Dec. 18, 2020

Related U.S. Application Data
(60) Provisional application No. 62/691,528, filed on Jun. 28, 2018.
(60) Provisional application No. 62/785,171, filed on Dec. 26, 2018.
(60) Provisional application No. 62/785,172, filed on Dec. 26, 2018.

(51) Int. Cl. C09D 5/16; C09D 5/14; C09D 7/45; C09D 7/43; C09D 7/61; C09D 7/40; C09D 175/04; C09D 183/06

(52) U.S. Cl. CPC C09D 5/1675; C09D 5/14; C09D 7/45; C09D 183/06; C09D 7/61; C09D 7/67; C09D 175/04; C09D 7/43

(57) ABSTRACT

The current disclosure describes a polymer composite which can comprise a polyurethane and a functionalized polyalkyl-siloxane. Polymer composites described herein can be useful for having and/or enhancing antifouling activity.

### CROSS-REFERENCE TO RELATED APPLICATIONS

This application claims the benefit of United States Provisional Application Nos. 62/691,528, filed Jun. 28, 2018; 62/785,171, filed Dec. 26, 2018; and 62/785,172, filed Dec. 26, 2018, which are incorporated by reference in their entirety.

### FIELD

The current disclosure describes polymer composites useful in antifouling coatings.

### BACKGROUND

The need for surfaces having non-fouling characteristics has stimulated the development of advanced materials for use in biomedical, marine and food processing applications, and in other applications where self-cleaning is needed.

In biomedical applications, a major problem associated with implant devices is the formation of biofilm on the device surface and infection associated with the bacteria harbored in the biofilm. Antibiotics usually are not effective towards bacteria inside the biofilm. Thus, an effective anti-biofilm surface coating is needed.

In marine environments, surfaces become fouled rapidly due to biofouling. Biofouling is the unwanted accumulation of microorganism, plants, algae and animals on artificial structures immersed in water, such as sea, river or lake water. Current methods to combat biofouling include coatings containing environmentally unfriendly biocides or foul-release film which only remove the fouling when the boat or other marine vessel is moving.

In food industry settings, such as fresh food processing or beer/wine manufacturing, contamination on the equipment surface is a concern. The high nutrient content left on a food/beverage preparation surface provides bacteria regions to grow and thus poses a threat to food safety and hygiene control. Stainless-steel surfaces usually used in food processing equipment may be modified to be superhydrophobic, but this modification usually involves environmentally unfriendly fluorinated materials and complicated nanostructure.

Thus, a need for a better antifouling surface coating is desired.

### SUMMARY

The present disclosure describes novel polymer composites and surface coatings that are effective to reduce or eliminate the attachment of biological materials, organic matter, or organisms to surfaces, particularly surfaces in contact with water or in aqueous environments. Generally, the polymer composites and coatings of the present disclosure are termed “antifouling” for their ability to reduce or prevent adhesion of biological or organic matter such as proteins, bacteria, and the like to the coated surfaces. The current disclosure includes a polymer composite comprising a first polymer and a second polymer. In some embodiments, the first polymer is a polyurethane polymer. In some embodiments, the second polymer is a polysiloxane polymer. In some cases, the polysiloxane polymer is a functionalized polysiloxane polymer. In some embodiments, the functionalized polysiloxane can have hydrophilic pendant side chains. In some embodiments, the polyurethane polymer and the functionalized siloxane polymer are mutually miscible within each other. In some embodiments, the polyurethane can be a polyurethane polymer dispersion. In some embodiments, the hydrophilic pendant side chain of functionalized polysiloxane can comprise an ethylene oxide or carbinol functional group. In some embodiments, the functionalized polysiloxane can comprise a mixture of polysiloxane with ethylene oxide pendant side chains and polysiloxane with carbinol group pendant side chains. In some embodiments, the functionalized siloxane can be substantially dispersed throughout the polyurethane.

In some embodiments, the composite can further comprise a surfactant. In some embodiments, the polymer composite further comprises an acrylate polymer. In some examples, the polymer composite further comprises an antimicrobial agent. Some embodiments include silver nanoparticles as the antimicrobial agent. Other embodiments include additional materials such as thickeners or crosslinkers to modify the viscosity of the mixture.

Some embodiments include a method of making an antifouling polymer composite. In some embodiments, the method comprises providing a functionalized polysiloxane and a polyurethane aqueous dispersion, wherein the two polymers are miscible, creating a substantially uniformly dispersed blend.

Some embodiments include a method for preventing liquid contamination of a surface. In some embodiments, the method comprise placing a polymer composite described herein in contact with the surface and allowing a coating to form on the surface. Some embodiments include a method for preventing fouling of a surface comprising at least the step of placing in contact with the surface a polymer composite described herein.

In some embodiments, the antifouling polymer composites have a very low liquid sliding angle. In some embodiments, the antifouling polymer composites have a very low water contact angle. In some embodiments, the antifouling polymer composites have an anti-biofilm activity at least 88% relative to an untreated surface. In some embodiments, the antifouling polymer composites have an antimicrobial activity at least 1,000 times greater than an uncoated surface.

In some embodiments, the antifouling polymer composites can be prepared in a manner that is more practical, less costly, and more environmentally friendly than known antifouling compositions.

### BRIEF DESCRIPTION OF THE DRAWINGS

FIG. 1 is a schematic showing a coated substrate of the current disclosure.

### DETAILED DESCRIPTION

Described herein are polymer composite coatings that have antifouling properties. In some embodiments, the polymer composite comprises a first polymer and a second polymer. In some embodiments, the first polymer of the polymer composite comprises a polyurethane polymer. In some examples, the second polymer of the polymer composite comprises a polysiloxane polymer. In some examples, the polysiloxane polymer is a functionalized polysiloxane polymer. In some embodiments, the polysiloxane polymer is functionalized with hydrophilic pendant groups. In some cases, the polyurethane polymer and the functionalized polysiloxane polymer are miscible. In some embodiments, the composite further comprise an acrylate polymer. In some examples, the polymer composite comprises a surfactant. In some embodiments, the composite coating comprises an antimicrobial agent. Some composite coating embodiments include additional materials such as crosslinkers or thickeners. Also described herein are methods for preparing the polymer composite coatings of the disclosure. Some embodiments include methods for using the embodiments of the disclosure as antifouling coatings. In some embodiments, a low liquid sliding angle is described. In some examples, a low water contact angle is demonstrated. In some embodiments, a high anti-biofilm activity versus P. aeruginosa is shown. In some embodiments, a high antimicrobial activity versus E. coli is shown.

Polymer composites described herein can be useful for having and/or enhancing antifouling activity. Polymer composites described herein can be useful for having and/or enhancing anti-staining activity. Polymer composites described herein can be useful for having and/or enhancing the cleaning of substrate surfaces exposed to fouling and/or staining mixtures.

In many embodiments, the polymer composite comprises a polyurethane polymer. The polyurethane polymer component of the polymer composite may be provided in a variety of forms. In some embodiments, the polyurethane can be a polyurethane resin and/or an aqueous polyurethane dispersion. In some embodiments, the polymer composite comprises an aliphatic polyether polyurethane dispersion. In some cases, the polyether polyurethane comprises Alberdingk Boley U205. In some examples, the polymer composite comprises an aliphatic polycarbonate polyurethane. In some embodiments, the polycarbonate polyurethane comprises Alberdingk Boley U6800. In some embodiments, the polymer composite comprises a polyester polyurethane. In some cases, the polyester polyurethane comprises Mitsui Takelac WS-5000. Other suitable polyurethane dispersions may include U6150, Allnext TW 6490/35WA, TW 6491/33WA, TW 6492/36WA, VTW 1262/35WA, Brenntag Witcobond 781, Witcobond W-240, Witcobond 386-03, Witcobond A-100, and Witcobond W-320. In some embodiments, the polyurethane can be made from thermoplastic resin, or water-based polymer dispersion. In some examples, the polymer can be a polyurethane matrix. It is believed that the polyurethane selected displays good film forming ability (film forming temperature <0° C.), good elasticity (max elongation before break >400%), and good hydrolysis resistance. It is believed that the polyurethane used in the embodiments of the current disclosure contribute these toughness and elasticity properties to the polymer composites.

Any suitable amount of polyurethane may be used in an antifouling polymer composite, such as about 0.1-10 wt %, about 10-20 wt %, about 20-30 wt %, about 30-40 wt %, about 40-50 wt %, about 50-60 wt %, about 60-65 wt %, about 65-70 wt %, about 70-73 wt %, about 73-76 wt %, about 76-80 wt %, about 80-83 wt %, about 83-86 wt %, about 86-89 wt %, about 89-92 wt %, about 92-95 wt %, about 95-97 wt %, or about 97-100 wt %, based upon the total weight of the antifouling polymer composite.

In some embodiments, the polymer composite comprises a polysiloxane. In some examples, the polysiloxane can be a polydialkylsiloxane. In some embodiments, the polydialkylsiloxane can be polydimethylsiloxane (PDMS). In some embodiments, the polysiloxane can be a hydrophilic silicone. In some embodiments, the hydrophilic silicone can comprise a dimethylsiloxane molecular backbone in which some of the methyl groups are replaced by polyalkyloxyalkyl ether groups or polyalkyloxyalkyl hydroxyl groups linked through a propyl group to the silicone atom. In some embodiments, the hydrophilic silicone can comprise a dimethylsiloxane molecular backbone in which some of the methyl groups are replaced by polyethylene glycol groups linked through a propyl group to the silicone atom. In some embodiments, the hydrophilic pendant side chain of functionalized polysiloxane can comprise an ethylene oxide or carbinol functional group. In some embodiments, the functionalized polysiloxane can comprise a mixture of polysiloxane with ethylene oxide pendant side chains and polysiloxane with carbinol group pendant side chains. In some embodiments, both ethylene oxide and carbinol functionalized polysiloxanes can be included in the polymer composite.

The term ethylene oxide refers to a functional group and/or substituent including the structure:

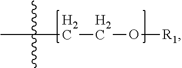

wherein R₁═H or —CH₃.

The term carbinol refers to a functional group and/or substituent including the structure:

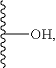 [SMILES: *O]

carbinol.

In some embodiments, the polysiloxane can be:

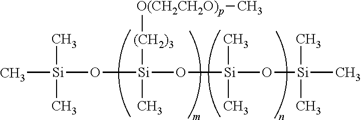

wherein m=1-40 and n=1-40 and p=1-150.

In some embodiments, the functionalized siloxane can be of the formula:

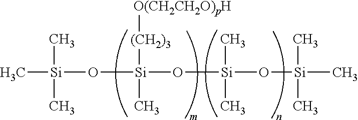

wherein m and n are described above and p=1-150.

The term “% substitution” is defined as (m/(m+n)×100%). In this definition, m refers to the amount the dimethylsiloxane units functionalized with hydrophilic side chain siloxane units (ethylene oxide or carbinol as shown above) an n refers to the amount of unfunctionalized dimethylsiloxane units. Therefore, m/(m+n) defines the percentage of hydrophilic pendant side chain siloxane in the entirety of the polysiloxane polymer. In some embodiments, the % substitution can be about 1% to about 90% substitution, about 1-2.5%, about 2.5-5%, about 5-10%, about 10-15%, about 15-20%, about 20-25%, about 25-30%, about 30-35%, about 35-40%, about 40-45%, about 45-50%, about 50-55%, about 55-60%, about 60-65%, about 65-70%, about 70-75%, about 75-80%, about 80-85%, about 85-90%%, about 1-10%, about 10-20%, about 20-30%, about 30-40%, about, 40-50%, about 50-60%, about 60-70%, about 70-80%, about 80-90%, about 2.5%, about 30%, about 50%, about 75%, about 90%, or any combination of these substitution ranges. It is believed that a minimum amount of hydrophilic pendant side-chains are useful in improving the miscibility of the polysiloxane in the water based polymer, e.g., polyurethane. It is further believed that the suitable % substitution by the pendant hydrophilic side chains (for example 5-30% substitution), makes the spacing of the hydrophilic pendant side chains loose enough so that they have freedom to swing and rotate, and/or can be swellable by the compatible liquid, and behave like liquid in that condition.

In some embodiments, m can be 1-40, 1-5, 5-10, 10-15, 15-20, 20-25, 25-30, 30-35, 35-40, 1-10, 1-20, 5-15, 10-20, 15-25, 20-30, or 30-40. In some embodiments, n can be 1-40, 1-5, 5-10, 10-15, 15-20, 20-25, 25-30, 30-35, 35-40, 1-10, 1-20, 5-15, 10-20, 15-25, 20-30, or 30-40. In some embodiments, the length of the ethylene oxide side chain, p, can be 1-150, or 1-20. In some embodiments, p can be 1-2, 1-3, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 1-10, 1-5, or 1-3.

Suitable hydrophilic polysiloxanes comprise dimethylsiloxane-(30-35% ethylene oxide) block copolymer DBE-311 (Gelest, Inc., Morrisville, Pa., USA), dimethylsiloxane-(60-70% ethylene oxide) block copolymer DBE-712 (Gelest), dimethylsiloxane-(85-90% ethylene oxide) block copolymer DBE-921 (Gelest), and (20% carbinol functional) methylsiloxane-dimethylsiloxane copolymer CMS-221 (Gelest), or any combination of any of these hydrophilic polysiloxanes.

The hydrophilic polysiloxane is physically mixed with thermoplastic polyurethane resin, or water-based polymer dispersion, when preparing the solution for coating. The hydrophilic side chain of polysiloxane enables even mixing with water-based polymer dispersion. In some embodiments, the hydrophobic PDMS backbone can enable an even mixing with thermoplastic polyurethane. The physical mixing of a hydrophilic PDMS dispersion with a preformed polyurethane resin or water based polyurethane dispersion provides a very simple, economical, and more practical way to prepare these polymer composites than other methods. Also, the process in the present disclosure may not involve organic solvent[s] and/or catalyst[s] that are usually used in multi-component polyurethane compositions, making the process more environmental friendly.

In some embodiments, the functionalized polysiloxane is substantially miscible in the polyurethane resin. In some embodiments, the functionalized polysiloxane can be sufficiently miscible in the polyurethane resin to create a substantially uniformly mixed blend. The uniformly mixed blend is indicated by the smooth liquid film left on the container wall when the container is tilted or the smooth liquid on the substrate when casted by a blade. In some embodiments, the hydrophilic polymer and the functionalized polysiloxane can be mutually miscible within each other. In some embodiments, the blend of the hydrophilic polymer and the functionalized polysiloxane can be a homogeneous solution at any ratio to each other.

In some embodiments, the weight percent of the functionalized polysiloxane in polyurethane polymer matrix can be about 1-30 wt %, about 1-2 wt %, about 2-3 wt %, about 3-4 wt %, about 4-5 wt %, about 5-6 wt %, about 6-7 wt %, about 7-8 wt %, about 8-9 wt %, about 9-10 wt %, about 10-11 wt %, about 11-12 wt %, about 12-13 wt %, about 13-14 wt %, about 14-15 wt %, about 15-16 wt %, about 16-17 wt %, about 17-18 wt %, about 18-19 wt %, about 19-20 wt %, about 20-21 wt %, about 21-22 wt %, about 22-23 wt %, about 23-24 wt %, about 24-25 wt %, about 25-26 wt %, about 26-27 wt %, about 27-28 wt %, about 28-29 wt %, about 29-30 wt %, about 1-5 wt %, about 5-10 wt %, about 10-15 wt %, about 15-20 wt %, about 20-25 wt %, about 25-30 wt %, about 1-10 wt %, 10-20 wt %, 20-30 wt %, 2-20 wt %, about 5-30 wt %, about 5-10 wt %, 5 wt %, 10 wt %, or any weight percent of functionalized polysiloxane incorporating any of the aforementioned values.

In some embodiments, the polymer composite can comprise a surfactant. In some embodiments, the addition of the surfactant to the polymer composite can provide the desired miscibility characteristics. In some embodiments, the surfactant can comprise hydrophilic groups. In some embodiments, the hydrophilic groups can be polyether group.

In some embodiments, the polyether groups can be polyoxyethylene groups, which are polymers of ethylene oxide. In some embodiments, the surfactant can comprise a sorbitan group. In some embodiments, the surfactant comprises polyoxyethylene (20) sorbitan monolaurate (Tween20), polysorbate 40 (polyoxyethylene (20) sorbitan monopalmitate), polysorbate 60 (polyoxyethylene (20) sorbitan monostearate), polyoxyethylene (20) sorbitan monooleate (Tween 80), or any combination thereof.

Any suitable amount of surfactant (e.g. Tween 80) may be used, such as about 1-30 wt %, about 1-2 wt %, about 2-3 wt %, about 3-4 wt %, about 4-5 wt %, about 5-6 wt %, about 6-7 wt %, about 7-8 wt %, about 8-9 wt %, about 9-10 wt %, about 10-11 wt %, about 11-12 wt %, about 12-13 wt %, about 13-14 wt %, about 14-15 wt %, about 15-16 wt %, about 16-17 wt %, about 17-18 wt %, about 18-19 wt %, about 19-20 wt %, about 20-21 wt %, about 21-22 wt %, about 22-23 wt %, about 23-24 wt %, about 24-25 wt %, about 25-26 wt %, about 26-27 wt %, about 27-28 wt %, about 28-29 wt %, about 29-30 wt %, about 1-5 wt %, about 5-10 wt %, about 10-15 wt %, about 15-20 wt %, about 20-25 wt %, about 25-30 wt %, about 1-10 wt %, 10-20 wt %, 20-30 wt %, 2-20 wt %, about 5-30 wt %, about 5-10 wt %, 5 wt %, or 10 wt %, based upon the total weight of the antifouling polymer composite.

It is believed that a polyether containing surfactant can surround the polyether modified polysiloxane with hydrophobic ends pointing inside and hydrophilic ends pointing to the aqueous solution. As the polymer composition is applied on a substrate and drying, the hydrophobic portion of the polyether modified polysiloxane tend to accumulate on the coating surface meanwhile bringing the amphiphilic compound (surfactant) around them together to the surface, thus causing a high density of hydrophilic groups embedded just below the surface. Once the coating surface is exposed to aqueous solution, the large amount of hydrophilic chains extend to the aqueous solution at the interface, making the surface superhydrophilic.

In some embodiments, the surfactant can be a non-ionic surfactant. In some embodiments, the non-ionic surfactant can be, for example, polyoxyethylene alkylphenyl ether, polyoxyethylene alkyl ether, polyoxyethylene fatty ester, sorbitan fatty acid ester, polyoxyethylene sorbitan fatty acid ester, polyoxyalkylene alkyl ether, polyoxyethylene derivative, glycerin fatty acid ester, polyoxyethylene hydrogenated castor oil, polyoxyethylene alkylamine, alkyl alkanol amide, or acetylene alcohol, acetylene glycol, and their ethylene oxide adduct. In some embodiments, the surfactant can be a lipophilic surfactant.

In some embodiments, the antifouling polymer composite can further comprise an acrylic polymer. In some embodiments, the acrylic polymer can be an acrylic polymer emulsion. In some embodiments, the acrylic polymer can be AP609LN and/or AP4609N (Showa Denko Group, Tokyo, Japan).

In some embodiments, the antifouling polymer composite can further comprise an anti-microbial agent. In some embodiments, the anti-microbial agent can be silver nanoparticles.

In some embodiments, thickeners or crosslinkers may be added to the antifouling polymer composite to achieve the desired viscosity. Suitable thickeners include Optiflo T1000, Bayhydur XP2547, and Aerosil R50.

The functionalized polysiloxanes employed herein are amphiphilic. Formation of a polyurethane coating having an amphiphilic surface can, for example, be accomplished by combining together the hydrophilic polysiloxanes and the polyurethane polymer. In an aqueous system, the low surface energy polysiloxane will naturally aid in bringing the hydrophilic chains to the surface, and will remain dispersed in the polyurethane so that it is incorporated into the coating system. Therefore, the surface of the material will be amphiphilic while the polyurethane bulk will give toughness to the system.

It is believed that the functionalized polysiloxane makes the coating hydrophilic and/or can have very low liquid sliding angle (water sliding angle <10°), in which liquid droplets coming into contact with the coating surface can easily slide off the surface leaving no/minimal residue. Such a coating can effectively prevent contamination from various liquids and the fouling that comes with the liquid such as biofouling, protein fouling, and marine fouling, and provides self-cleaning properties of the surface against contaminants like dust, etc.

While materials with ethylene oxide content of 75% and higher are freely soluble in water, the miscibility was surprisingly better when the % substitution was about 5% to about 30% as described above. It is believed that when the weight percent of the functionalized PDMS and the % substitution of the side chain are within the ranges disclosed herein, a hydrophilic polymer brush with medium density may be formed on the coating surface, such that the polymer brush can be readily swellable when contacting with the target liquid, and that it behaves like liquid that facilitates the sliding of target liquid droplets even at small tilt angle and/or leave no/minimal residue. The smaller the sliding angle, the easier the liquid is removed from the surface, thereby rendering antifouling and self-cleaning functions. When the weight percentage and/or the % substitution of side chain may be too high, the polymer brush on the coating surface can be very dense and thus may not be that swellable because there may be limited room between the polymer brush chains for them to rotate and bend. In these cases, the surface does not behave like liquid as in the desired embodiments, and is merely hydrophilic. Furthermore when the weight percentage and/or the % substitution of side chain may be too high, the sliding angle may not be as low as desired and liquid droplets slides off the surface it could leave behind a tail-like trail which can essentially leave the contaminants on the surface.

When the weight percent of the functionalized polydimethylsiloxane and the % substitution of the side chain are within the ranges described in the present disclosure, a hydrophilic polymer brush with medium density may be formed on the coating surface such that the polymer brush can be readily swellable when contacting with target liquid, and that it behaves like a liquid that facilitates the sliding of target liquid droplets even at small tilt angles, leaving no or minimal residue.

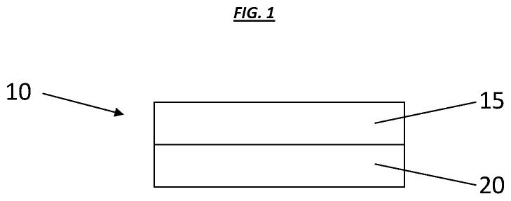

As shown in FIG. 1, in some embodiments, a coating, such as coating 10 can comprise the aforedescribed polymer composite. In some embodiments, the polymer composite, such as composite 15, can be disposed upon a substrate surface, such as the substrate 20 surface, and dried. In some embodiments, the coating can be dried by spray coating, casting, dip coating, brush coating or roller coating.

In some embodiments the resultant dried polymer composite can be 1-1000 μm (micrometer) thick. In some embodiments, the composite can be about 1-50 μm, about 50-100 μm, about 100-150 μm, about 150-200 μm, about 200-250 μm, about 250-300 μm, about 300-350 μm, about 350-400 μm, about 400-450 μm, about 450-500 μm, about 500-550 μm, about 550-600 μm, about 600-650 μm, about 650-700 μm, about 750-800 μm, about 850-900 μm, about 900-950 μm, about 950-1000 μm, about 50-600 μm, about 625 μm, or about 300 μm thick.

In some embodiments, the dried coating can be peelable with controllable peel strength with range of 1-20N/20 mm.

Some embodiments include a method of making a polymer composite. In some embodiments, the method can comprise providing a hydrophilic pendant side chain functionalized polysiloxane dispersion and a polar polyurethane dispersion and physically mixing the miscible modified polysiloxane with the polar polyurethane. In some embodiments, the method can further comprise adding a surfactant. In some embodiments, the method can further comprise adding an acrylic polymer. In some embodiments, the method can further comprise adding anti-microbial silver nanoparticles. In some embodiments, the method can further comprise adding a thickener.

Some embodiments include a method for facilitating the removal of water and/or aqueous solutions from a surface. In accordance with the present disclosure, a “surface” is any part of a piece of equipment which may come into contact with water soluble materials. The surface may comprise the entire surface which may come in contact with one or more of the aforedescribed materials, or a part of such entire surface. In the context of the dairy industry, equipment may include for example, the plant or any individual part thereof, such as vats, vessels, pumps, tans, mixers, coolers, pipelines and the like, or equipment and vessels involved in milking, packaging or shipping dairy products such as milk. Surfaces and equipment of relevance to other industries will readily be appreciated by skilled persons. However, by way of general example, these may include bioreactors, fermentation vats and the like.

In some embodiments, the water or aqueous solution to be removed can comprise a protein. In some embodiments, the aqueous solution can comprise a carbohydrate. In some embodiments, the method comprises coating the substrate with the compositions described herein, such that the solution or the materials contained within the solution may be more easily removed from the substrate than from an uncoated substrate. In some embodiments, the method facilitates or reduces the cleaning of a fluid containing a protein and/or a carbohydrate. In some embodiments fluid containing a protein and/or a carbohydrate can be beer or wort. In some embodiments, the fluid containing a protein, and/or a carbohydrate can be milk or other dairy products. In some embodiments, the method reduces fouling of a surface comprising at least the step of placing in contact with the surface a composition described herein. In some embodiments, the composition to be placed in contact comprises a polymer. In some embodiments, the composition to be placed in contact comprises a surfactant described elsewhere herein. In some embodiments, the composition to be placed in contact comprises a polysiloxane. In some embodiments, the composition to be placed in contact comprises a hydrophilic polymer, a polysiloxane, and/or a surfactant or any combination or permutation of the aforedescribed and to allow the coating to form on the surface. In some embodiments, a method of processing a composition containing one or more proteins is described, the method comprising at least the steps of: a) preparing a surface of any equipment in accordance with a method described herein; and, b) processing with the equipment, the fluid, food and/or composition containing one or more proteins and/or carbohydrates.

Those of ordinary skill in the art recognize ways to determine the dewetting property of the surface. One example can be determining the slide angle of the treated substrate by the decrease of the angle at which the sample begins to slide off the treated substrate. In one example, a 20 microliter (pi) droplet of deionized water can be placed upon a treated steel substrate and the substrate surface was tilted from the horizontal until the droplet was visually perceived to slide and leave no/minimal residue behind it, as more fully described in Example 3. In some embodiments, the slide angle of the described coating can be less than 30°, less than 25°, less than 20°, less than 15°, less than 12.5°, less than 10°, about 5-10°, about 10-15°, about 15-20°, about 20-25°, or about 25-30° from the horizontal.

The term “hydrophilic” refers to a compound/solution/mixture that has a water contact angle of less than 90 degrees.

The term “superhydrophilic” surface refers to a surface on which water/liquid spreads to nearly zero contact angle (for example, <5°, <4°, <3°, <2°, <1°, <0.5°).

Those of ordinary skill in the art recognize ways to determine the hydrophilicity of a surface by measuring the contact angle of a fluid upon the treated surface. In one example, a 20 μl droplet of deionized water and/or a beer or wort can be placed upon a treated steel substrate and the surface area and/or the contact angle of the resultant droplet can be ascertained, as more fully described in Examples 3 and/or 5. In some embodiments, the contact angle of the described coating can be less than 25°, less than 20°, less than 15°, less than 12.5°, less than 10°, less than 5°, about 1-5°, about 5-10°, about 10-15°, about 15-20°, or about 20-25°. In some embodiments, the change in surface area of an amount of liquid on a given treated substrate, such as stainless-steel, can be greater than 25%, about 25-50%, about 50-75%, about 75-100%, about 100-250%, about 250-500%, about 500-1000%, or greater than 1000% of the amount on an untreated surface.

Those of ordinary skill in the art recognize ways to determine the anti-biofilm property of the surface. In some embodiments, the ability of the coating to inhibit biofilm formation on its surface can be tested in a Center for Disease Control (CDC) biofilm reactor in comparison with other common perceived hydrophobic material like PTFE and antifouling materials like Ag and Cu sheet, as more fully described in Example 4. In some embodiments, the described coating can suppress the growth of P. aeruginosa biofilm by 25-90%, 25-30%, 30-35%, 35-40%, 40-45%, 45-50%, 50-55%, 55-60%, 60-65%, 65-70%, 75-80%, 80-85%, 85-90%, 28%, 38%, 49.7%, 80%, or 88% as compared to the reference untreated stainless-steel plate.

Those of ordinary skill in the art recognize ways to determine the antimicrobial effect of the coating of the surface. In some embodiments, the ability of the coating to inhibit E. coli growth after 24 hours of contact is at least 100 fold, at least 500 fold, at least 1,000 fold, at least 10,000 fold, at least 100,000 fold, at least 1,000,000 fold, about 100-1,000 fold, about 1,000-10,000 fold, about 10,000-100,000 fold, or about 1,000,000 fold superior to the reference untreated stainless-steel plate.

Exemplary but non-limiting embodiments are as follows:

Embodiment 1. A polymer composite comprising:
a polymer; and
a functionalized polysiloxane, wherein the functionalized polysiloxane has hydrophilic pendant side chains, wherein the functionalized polysiloxane and the polymer are mutually miscible within each other.

Embodiment 2. The polymer composite of embodiment 1, wherein the polymer is a polyurethane dispersion.

Embodiment 3. The polymer composite of embodiment 1, further comprising an acrylic polymer emulsion.

Embodiment 4. The polymer composite of embodiment 1, further comprising an anti-microbial agent.

Embodiment 5. The polymer composite of embodiment 4, wherein the anti-microbial agent comprises silver nanoparticles.

Embodiment 6. The polymer composite of embodiment 1, wherein the hydrophilic pendant side chain of functionalized polysiloxane comprises an ethylene oxide or carbinol functional group.

Embodiment 7. The polymer composite of embodiment 1, wherein the functionalized polysiloxane comprises a mixture of polysiloxane with ethylene oxide pendant side chains and polysiloxane with carbinol group pendant side chains.

Embodiment 8. The polymer composite of embodiment 1, wherein the functionalized siloxane is substantially dispersed throughout the polyurethane.

Embodiment 9. The polymer composition of embodiment 1, wherein the functionalized polysiloxane has 5-30 wt % substitution with hydrophilic side-chains.

Embodiment 10. The polymer composition of embodiment 1, wherein the functionalized polysiloxane has a 1-30 wt % substitution with hydrophilic side-chains. Embodiment 11. The polymer composition of embodiment 1, wherein the functionalized polysiloxane is a polydialkylsiloxane.

Embodiment 12. The polymer composition of embodiment 11, wherein the functionalized polysiloxane is polydimethylsiloxane.

Embodiment 13. The polymer composition of embodiment 1, further comprising an amphiphilic surfactant.

Embodiment 14. The polymer composition of embodiment 13, wherein the surfactant is polyoxyalkylene sorbate.

Embodiment 15. A method for preventing liquid contamination of a surface comprising at least the step of placing in contact with the surface a composition of any one of embodiments 1-14 to allow the coating to form on the surface.

Embodiment 16. A method of processing an aqueous composition, the method comprising at least the steps of:
a) preparing a surface of any equipment in accordance with a method of any one of embodiments 1-14; and
b) processing with the equipment the composition containing the aqueous composition.

Embodiment 17. A method for preventing fouling of a surface comprising at least the step of placing in contact with the surface a composition comprising a waterborne polymer, hydrophobic surface modified particles and at least one amphiphilic compound to allow the coating to form on the surface.

Embodiment 18. A method of preparing a polymer composite, comprising:
providing a hydrophilically pendantly functionalized polysiloxane and a polyurethane aqueous dispersion; and
mixing the miscible functionalized polysiloxane and a polyurethane aqueous dispersion to create a substantially uniformly dispersed blend.

### Examples

It has been discovered that embodiments of the composite and/or compositions described herein have improved performance as compared to other compositions and/or the surfaces coated therewith. These benefits are further demonstrated by the following examples, which are intended to be illustrative of the disclosure only but are not intended to limit the scope or underlying principles in any way.

### I. Synthesis

### Example—1: Preparation of the Solution

150 g of water based polyurethane dispersion (PUD) U205 (Alberdingk Boley) was mixed with 4.5 g (^{˜}4.5 mM) dimethylsiloxane-(30-35% ethylene oxide) block copolymer DBE-311 (Gelest, Inc., Morrisville, Pa., USA) and the solution was stirred using magnetic stir bar at room temperature. A uniform solution was obtained after 12 hours of stirring. The viscosity of the resultant example was about 100-500 mPa. If the viscosity was below 100 mPa, a thickener like Aerosil R50 was added at 1-10 wt %.

### Additional Example (PUD+PDMS+Surfactant)

Additional examples were made in a manner similar to that described above except that the various constituents of the mixture were varied as described in Table 1 below, e.g., 2.25 g of Polyoxyethylene (20) sorbitan monooleate (Tween80) was mixed with the polyurethane and DBE-311 block copolymer. All the percentage stated here are solid weight percent in dried PU films unless otherwise specified. The solid content of PU dispersion is usually 30-40% unless specified otherwise.

TABLE 1

| | | | | Acrylic | Ag nano- |
|---|---|---|---|---|---|
| Composition | PU | PDMS | surfactant | polymer | particles |
| SSL 304 [CE-A1] | − | − | − | | |
| U205 [CE-A2], | + | − | − | | |
| U205 + Tween80 | + | − | + | | |
| (5%) [Ex-A1] | | | | | |
| U205 + DBE311 | + | + | − | | |
| (10%) [Ex-A2] | | | | | |
| U205 + DBE-311 + | + | + | + | | |
| Tween80 (5%) [Ex- | | | | | |
| A3] | | | | | |
| U205 (20% w/w) + | + | + | − | + | + |
| AP609LN (80% w/w) + | | | | | |
| DBE311 (5%) + AgNP | | | | | |
| (0.5 mg/mL) | | | | | |

### Example—1.2: Additional Examples (CE)

Additional examples were made as described above except that 4.5 g (4.5 mM) of a different ethylene oxide level substituted dimethylsiloxanes-block copolymer DBE-712 (60-70% ethylene oxide); or DBE-921 (85-90% ethylene oxide) (Gelest) were used instead of DBE-311. In another example, a hydroxylic silicone CMS-211, having an —OH group (20-25%) substituted instead of an ethylene oxide group was used instead of DBE-311.

### Example—1.3: Preparation of the Solution Using Aliphatic Polyether PU Dispersion and Acrylate Emulsion

5 g of water based aliphatic polyether polyurethane dispersion (PUD) U205 (Alberdingk Boley, Greensboro, N.C., USA) was mixed with 5 g of AP609LN (Showa Denko Group, Tokyo, Japan) and optionally 0.26 g of dimethylsiloxane-(30-35% ethylene oxide) block copolymer DBE-311 (Gelest, Inc., Morrisville, Pa., USA). The solution was mixed using Planetary Centrifugal Mixer THINKY ARE-310 (THINKY Corporation, Tokyo, Japan) for 3 min, then was defoamed using the same for 2 min. A uniform solution was obtained.

### Example—1.4: Preparation of the Solution Using Polyester PU Dispersion and Acrylate Emulsion

2 g of water based polyester polyurethane dispersion (PUD) Takelac WS-5000 (Mitsui Chemicals, Tokyo, Japan) was mixed with 8 g of AP609LN (Showa Denko Group, Tokyo, Japan). The solution was mixed using Planetary Centrifugal Mixer THINKY ARE-310 (THINKY Corporation, Japan) for 3 min, then was defoamed using the same for 2 min. A uniform solution was obtained.

### Example—1.5: Preparation of the Solution Using Aliphatic Polyether PU Dispersion, Acrylate Emulsion, and Silver Nanoparticles

30 g of water based polyurethane dispersion (PUD) U205 (Alberdingk Boley, Greensboro, N.C., USA) will be mixed with 30 g of AP609LN (Showa Denko Group, Tokyo, Japan), 1 g of dimethylsiloxane-(30-35% ethylene oxide) block copolymer DBE-311 (Gelest, Inc., Morrisville, Pa., USA), and 120 mg of silver nanoparticles (SkySpring Nanomaterials, Inc, Houston, Tex., USA). The solution will be mixed on a rolling mixer (US Stoneware, East Palestine, Ohio, USA) at room temperature. A uniform solution will be obtained after 24 hours of mixing.

In the above examples—10 & 11, other silver nanoparticles have also been used.
(1) PVP coated silver nanoparticles (99.95%, 20-30 nm, SkySpring Nanomaterials, Inc, Houston, Tex., USA)
(2) Oleic Acid coated silver nanoparticles (99.95%, 320-50 nm, SkySpring Nanomaterials, Inc, Houston, Tex., USA)

### Example—2: Preparation of the Antifouling Coating

The solution from example 1 was casted on a stainless steel substrate using a blade caster, using a wet thickness 625 μm, after dried in air at room temperature, a dry coating of 300 μm thickness was obtained. The coating can also be brush coated or roller coated.

### Example—3: The Sliding Angle Measurement of the Antifouling Coating

The substrate was fixed on a rotatable/tiltable stage. 20 μl of DI water is placed on the horizontal surface of tested substrate by pipette, then the substrate was tilted slowly at a speed <1 degree/second, and the action of tilting was stopped for 5 second at every 5 degree increment and the movement of the droplet was monitored. The results are shown in Table 2 below. The coating of U205+DBE311 (5-10%) on stainless steel dramatically decreased the water sliding angle from 90 degree to 10-15 degree, on the other hand, even for the most well-known non-sticking hydrophobic polymer PTFE, the 20 μl water droplet pinned on the PTFE surface even at 90 degrees.

This unique feature of the present disclosed materials can make it a very attractive and practical solution for antifouling application.

TABLE 2

| | | | water sliding |
|---|---|---|---|
| | | Hydrophilic | angle |
| Surface | Polymer(s) | PDMS Polymer | (20 μL) |
| Stainless | | | 90 |
| steel (SSL) | | | |
| PTFE | | | 90 |
| PU-1/SSL | U205 | DBE-311 (5%) | 15 |
| | | 30% EO substitution | |
| PU-2/SSL | U205 | DBE-311 (10%) | 10 |
| | | 30% EO substitution | |
| PU-3/SSL | U205 | DBE-712 (5%) | 29 |
| | | 60-70% EO substitution | |
| PU-4/SSL | U205 | DBE-921 (5%) | 50 |
| | | 85-90% EO substitution | |
| PU-5/SSL | U205 | CMS-221 (5%) | 21 |
| | | 20% HO-EO substitution | |
| PU-6/SSL | U205 | DBE-311 (10%) | 10 |
| | | 30% EO substitution + | |
| | | 5% Tween80 | |
| PU-7/SSL | U205 (20% | DBE-311 (10%) | 30 |
| | w/w) + AP609LN | 30% EO substitution | |
| | (80% w/w) | | |

### Example—4: Biofilm Growth Test in CDC Biofilm Reactor

Coupons of U205+DBE311 (10%) film on stainless steel, PTFE, untreated stainless steel with size of 2 cm×12 cm were fixed into the sample holder of a CBR 90-3 CDC Biofilm Reactor® produced by Center for Biofilm Engineering at Montana State University). The growth of biofilm on those surfaces was evaluated using Standard Test Method for Quantification of Pseudomonas aeruginosa Biofilm Grown with High Shear and Continuous Flow using CDC Biofilm Reactor (ASTM standard E2562-17). The data in table 3 shows that U205+DBE311 was the most effective inhibiting the growth of Pseudomonas aeruginosa Biofilm on its surface among all the samples, the biofilm on U205+DBE311 is only 12% compared to that on the reference untreated stainless steel, PTFE being 60% and biocide Cu plate being 70% and Ag plate being 20%.

TABLE 3

| | Anti-biofilm (biofilm formation relative to |
|---|---|
| Material | that on stainless steel, in P. aeruginosa) |
| Stainless steel | 100% |
| PTFE | 62% |
| Cu plate | 72% |
| Ag plate | 20% |
| U205 | 50.3% |
| U205 + DBE311 (10%) | 12% |

### Example—5: The Contact Angle Measurement and Water Droplet Area Measurement of the Antifouling Coating

For the water contact angle measurement, the substrate was placed on the stage of a contact angle meter Attension Theta lite TL 100 (Finland). 20 μl of DI water is placed on the horizontal surface of tested substrate by pipette, then the contact angle was measured and analyzed by the contact angle meter. The water contact angles of various coatings are shown in Table 4. All the coatings presented in this disclosure showed water contact angle less than 5°, indicating they are super-hydrophilic.

For the water droplet area measurement, 200 μl of DI water is placed on the horizontal surface of tested substrate by pipette. Comparing to the bare stainless steel, the size of water droplets on the coating is 5-11 times bigger.

This unique feature of the present disclosed materials can make it a very attractive and practical solution for antifouling application.

TABLE 4
The size of a 200 μL water droplet on the
coatings compared for bare stainless steel

| | | Water | |
|---|---|---|---|
| | | contact | |
| Surface | Composition | angle (°) | Area (cm²) |
| Stainless steel | | 60-70 | 1.1 |
| Polyether | U205 + DBE-311(10%) + | <5 | 9.9 |
| PU/SSL | Tween80 (5%) | | |

### Example—6. Antimicrobial Testing

Start an overnight (ON) culture the day before inoculation, using bacterial species E. coli (ATCC 8739) and growing in 3 mL of TSA media in a 37° C. shaker for overnight at 200 rpm.

The next day, start a re-growth (RG) culture by adding 100 μl of the above ON culture into 10 mL of fresh media. Grow at 37° C. with shaking for 2 hours. Dilute RG culture 50× (this gives a density of ^{˜}2×106 CFU/mL). This is the inoculation solution (IN). Place a sample in a 10 cm petri dish with a water soaked filter paper at the bottom. Inoculate 50 μl of the IN onto the sample. Place a 0.75″×1.5″ clear film on the inoculum. The liquid will spread to the size of the film. Add lid to the petri dish. Incubate at room temperature (21-23° C.), for 2 hours.

At the end of incubation, use sterile forceps to hold the sample in the opening of an empty 50 mL conical tube. Use a pipet tip to push the film into the tube. Wash the sample surface with 10 mL of saline solution (ensure that the washing solution goes directly into the tube. This is the washout). Close the lid on the conical tube, and invert the tube gently 60×. Ensure the liquid flow over the cover film as much as possible. Serial dilute the washout, and plate onto TSA agar.

After an incubation period of 24 hours at room temperature (21-23° C.), count and record the colony number on plates. See results in Table 5 below.

TABLE 5
Antimicrobial effect of the coating on stainless steel

| | Antimicrobial effect to |
|---|---|
| | E. coli (log reduction |
| | relative to stainless steel, |
| Composite | after 24 hours of contact) |
| U205 + DBE311 (10%) | 3 |
| U205(20% w/w) + AP609(80% w/w) + | 5 |
| DBE311(5%) + AgNP(0.5 mg/mL) + | |
| T1000(3% wt) + XP2547 (10% wt) | |

Unless otherwise indicated, all numbers expressing quantities of ingredients, properties such as molecular weight, reaction conditions, and so forth used in the specification and embodiments are to be understood as being modified in all instances by the term “about.” Accordingly, unless indicated to the contrary, the numerical parameters set forth in the specification and attached embodiments are approximations that may vary depending upon the desired properties sought to be obtained. At the very least, and not as an attempt to limit the application of the doctrine of equivalents to the scope of the embodiments, each numerical parameter should at least be construed in light of the number of reported significant digits and by applying ordinary rounding techniques.

The terms “a,” “an,” “the” and similar referents used in the context of describing the present disclosure (especially in the context of the following embodiments) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of any embodiment. No language in the specification should be construed as indicating any non-embodied element essential to the practice of the disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended embodiments.

Certain embodiments are described herein, including the best mode known to the inventors for carrying out the present disclosure. Of course, variations on these described embodiments will become apparent to those of ordinary skill in the art upon reading the foregoing description. The inventors expect skilled artisans to employ such variations as appropriate, and the inventors intend for the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the embodiments. Other modifications that may be employed are within the scope of the embodiments. Thus, by way of example, but not of limitation, alternative embodiments may be utilized in accordance with the teachings herein. Accordingly, the embodiments of the present disclosure are not limited to embodiments precisely as shown and described.

1. An antifouling polymer composite, comprising:
a first polymer comprising a polyurethane; and
a second polymer comprising a functionalized polysiloxane comprising hydrophilic side chains;
wherein the first polymer and the second polymer are miscible.

2. The antifouling polymer composite of claim 1, wherein the first polymer comprises polyether polyurethane U205, polyester polyurethane WS-5000, polycarbonate polyurethane U6800, or any combination thereof.

3. The antifouling polymer composite of claim 1, wherein the second polymer comprises a functionalized polydimethylsiloxane comprising hydrophilic side chains.

4. The antifouling polymer composite of claim 1, wherein the hydrophilic side chains comprise an ethylene oxide functional group, a carbinol functional group, or any combination thereof.

5. The antifouling polymer composite of claim 1, wherein the polysiloxane is substituted with hydrophilic side chains in a percentage of about 1% substitution to about 90% substitution.

6. The antifouling polymer composite of claim 1, further comprising an acrylic polymer.

7. The antifouling polymer composite of claim 1, further comprising a surfactant.

8. The antifouling polymer composite of claim 7, wherein the surfactant is Tween80.

9. The antifouling polymer composite of claim 1, further comprising a thickener.

10. The antifouling polymer composite of claim 9, wherein the thickener is Optiflo T1000, Bayhydur XP2547, or Aerosil R50.

11. The antifouling polymer composite of claim 1, further comprising an antimicrobial agent.

12. The antifouling polymer composite of claim 11, wherein the antimicrobial agent comprises silver nanoparticles.

13. A surface coating, comprising the antifouling polymer composite of claim 1.

14. The surface coating of claim 13, wherein the surface to be coated is a food processing surface, a malt or wort processing surface, a surface prone to biofilm formation, or a medical device surface.

15. The surface coating of claim 13, wherein the surface comprises stainless steel.

16. The surface coating of claim 13, having a liquid sliding angle of about 10 degrees to about 30 degrees.

17. The surface coating of claim 16, having a water contact angle less than 5 degrees.

18. The surface coating of claim 13, having antimicrobial activity versus E. coli at least 1,000 times greater than an uncoated surface.

19. A method for making the antifouling polymer of claim 1, comprising mixing a first polymer comprising a polyurethane and a second polymer comprising a polysiloxane, wherein the polysiloxane is a functionalized polysiloxane comprising hydrophilic side chains, an acrylate polymer, a surfactant, a thickener, an antimicrobial compound, or any combination thereof.

20. A method of making the surface coating of claim 13, comprising:
coating a surface with the antifouling polymer composite by casting, brush coating, blade coating, spin coating, or roller coating; and
allowing to air dry.
